(19) United States
(12) Patent Application Publication
(10) Pub. No.: US 2024/0159099 A1
(43) Pub. Date: May 16, 2024

(54) Device for manufacturing vacuum-insulated glass

(71) Applicant: JP AUTOMATION CO., LTD., Gyeonggi-do (KR)

(72) Inventor: Woo Yun Park, Suwon-si (KR)

(21) Appl. No.: 18/284,049

(22) PCT Filed: May 2, 2022
(86) PCT No.: PCT/KR2022/006245

§ 371 Date: Sep. 25, 2023

(30) Foreign Application Priority Data
Jul. 14, 2021 (KR) 10-2021-0092168

(51) Int. Cl. E06B 3/677; E06B 3/66

(52) U.S. Cl. CPC E06B 3/6775; E06B 3/6612

(57) ABSTRACT

The present invention relates to a technology of manufacturing vacuum-insulated glass in various sizes through a single type of manufacturing device, that is, a technology of extracting air in vacuum-insulated glass with a manufacturing device for extracting air from vacuum-insulated glass disposed as a device separately from the vacuum-insulated glass without an existing closed-type vacuum chamber for keeping vacuum-insulated glass. According to the present invention, there is an advantage that it is possible to manufacture vacuum-insulated glass of various sizes using a single type of manufacturing device. Further, according to the present invention, there is an advantage that it is possible to prevent deformation of a sealing cap even though a vent-hole is large.

### FIELD OF THE INVENTION

The present invention relates to a technology of manufacturing vacuum-insulated glass in various sizes through a single type of manufacturing device.

More specifically, the present invention relates to a technology of extracting air in vacuum-insulated glass with a manufacturing device for extracting air from vacuum-insulated glass disposed as a device separately from the vacuum-insulated glass without an existing closed-type vacuum chamber for keeping vacuum-insulated glass.

### BACKGROUND ART

FIG. 1 is an exemplary view showing a portion of a conventional vacuum-insulated glass. FIG. 2 is a view schematically showing a vacuum chamber for manufacturing a conventional vacuum-insulated glass.

Referring to FIG. 1, vacuum-insulated glass is composed of two layers of first and second glass panels 10 and 20 spaced a predetermined distance by a plurality of spacers 30 and the air in the space therebetween is extracted, whereby the vacuum-insulated glass is maintained in a vacuum state. Insulation effect inside and outside such vacuum-insulated glass is good at places where the vacuum-insulated glass is installed.

Such vacuum-insulated glass may be manufactured using a closed-type vacuum chamber 60 shown in FIG. 2. Vacuum-insulated glass is put into the vacuum chamber 60, the air in the chamber is pumped out by a pump 70, and a sealing cap 50 is attached over a through-vent 21. Next, when first and second heaters 61 and 62 are moved in position and operated by an actuating cylinder 63, the sealing cap 50 attached over the through-vent 21 is intactly hardened. As a result, the space between the first and second glass panels 10 and 20 is maintained in a vacuum state.

However, the vacuum chamber 60 in which vacuum-insulated glass can be put in is required in the related art of FIG. 2. There is a problem that vacuum chambers 60 of various sizes should also be prepared to manufacture vacuum-insulated glass of various sizes. In this case, there is a problem that since vacuum chambers 60 of various sizes should be disposed together in a certain space, there is also a problem of a big spatial limitation. In particular, a big-sized vacuum chamber 60 was required to manufacture big-sized vacuum-insulated glass, which was a large load.

Meanwhile, FIG. 3 is a view showing an example when a sealing cap has been deformed by vacuum pressure in a conventional vacuum-insulated glass, depending on the size of a through-vent.

A sealing cap 50′ covering a through-vent 21′ formed at a second glass panel 20′ may be bent toward the space defined by the first and second glass panels 10′ and 20′ by vacuum pressure when the size of the sealing cap 50′ is large, as in (b) of FIG. 3. It may be considered to decrease the size of the through-vent 21′ in order to solve the problem of bending of the sealing cap 50′, but, in this case, there is a problem that it takes too much time to extract air through the through-vent 21′.

### DISCLOSURE OF INVENTION

### Technical Problem

An object of the present invention is to provide a device for manufacturing vacuum-insulated glass, the device making it possible to extract air in vacuum-insulated glass regardless of various sizes of vacuum-insulated glass through a single type of manufacturing device.

Further, another object of the present invention is to provide a device for manufacturing vacuum-insulated glass, the device being able to prevent inducing deformation of a sealing cap even for a big-sized through-vent.

### Technical Solution

In order to achieve the objects, a device for manufacturing vacuum-insulated glass is a device for manufacturing vacuum-insulated glass that is formed by stacking a first glass panel and a second glass panel having a through-vent, the device including: a vacuum cover member being in close contact with a first surface of the second glass panel that corresponds to an opposite side of the first glass panel in the form of covering a predetermined region of the second glass panel including the through-vent; a vacuum pumping member communicating with the vacuum cover member and configured to suction air between the first glass panel and the second glass panel via the vacuum cover member through the through-vent; a vacuum pipe member disposed such that the vacuum pumping member communicates with an inside of the vacuum cover member; a stroke member disposed through the vacuum cover member and configured to move into and out of the vacuum cover member with the inside and outside of the vacuum cover member sealed; and a sealing cap gripping member connected to a front end of the stroke member that corresponds to the inside of the vacuum cover member, configured to straightly move in linkage with a stroke of the stroke member, and configured to move to the through-vent with a sealing cap for sealing the through-vent gripped thereby and then to release the sealing cap.

The device for manufacturing vacuum-insulated glass according to the present invention may further include a bonding-hardening member elongated from an outside of the vacuum cover member through the vacuum cover member to the inside of the vacuum cover member with the inside and outside of the vacuum cover member sealed, and configured to provide a bonding environment for a bonding material of the sealing cap fastened to the through-vent.

Further, the device for manufacturing vacuum-insulated glass according to the present invention may further include a pressure gauge member communicating with the vacuum pipe member and configured to display vacuum pressure generated between the first glass panel and the second glass panel in accordance to the operation of the vacuum pumping member.

Further, the device for manufacturing vacuum-insulated glass according to the present invention may further include a vent member communicating with the vacuum pipe member and configured to release the vacuum pressure generated between the first glass panel and the second glass panel when being opened.

The sealing cap of the present invention may include: a sealing body member formed in a cylindrical shape with a closed front end and configured to be extended to and placed on a first surface of the first glass panel facing the second glass panel through the through-vent; and a sealing flange member to be bent outward from an edge of a rear end of the sealing body member and configured to be held on the first surface of the second glass panel that corresponds to an opposite side of the first glass panel.

In the present invention, the sealing cap gripping member may be made of an electromagnet.

### Advantageous Effects

According to the present invention, there is an advantage that it is possible to manufacture vacuum-insulated glass of various sizes using a single type of manufacturing device.

Further, according to the present invention, there is an advantage that it is possible to prevent deformation of a sealing cap even though a through-vent is large.

### BRIEF DESCRIPTION OF THE DRAWINGS

FIG. 1 is an exemplary view showing a portion of a conventional vacuum-insulated glass.

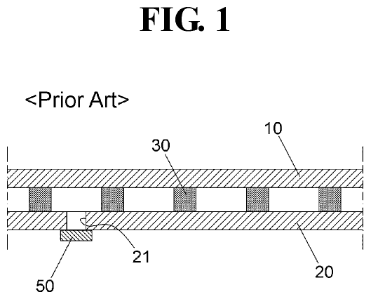

FIG. 2 is a view schematically showing a vacuum chamber for manufacturing a conventional vacuum-insulated glass.

FIG. 3 is a view showing an example of deformation of a sealing cap due to vacuum pressure in a conventional vacuum-insulated glass.

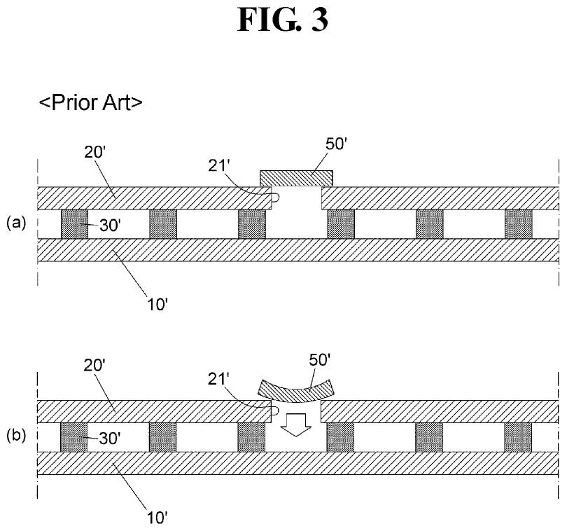

FIG. 4 is an exemplary view schematically showing a device for manufacturing vacuum-insulated glass according to the present invention.

FIG. 5 is a view showing a state in which the manufacturing device of FIG. 4 is seated on the top of a second glass panel.

FIG. 6 is a view showing a state in which a stroke member has moved down a sealing cap gripping member in FIG. 5.

FIG. 7 is a view showing a state in which the stroke member has moved up the sealing cap gripping member separated from the sealing cap in FIG. 6.

FIG. 8 is a view showing a state in which the manufacturing device of FIG. 7 has been separated from the top of the second glass panel.

FIG. 9 is an enlarged view showing a portion of FIG. 8.

FIG. 10 is an exemplary view showing a state before a sealing cap gripping member grips the sealing cap in another embodiment of the present invention.

FIG. 11 is an exemplary view showing a state immediately after the sealing gap gripping member grips the sealing cap in FIG. 10.

FIG. 12 is an exemplary view showing a state in which the stroke member has been straightly moved down in the state of FIG. 11.

FIG. 13 is an exemplary view showing a state in which the stroke member has been straightly moved up after the sealing cap gripping member released the sealing cap.

### DESCRIPTION OF EMBODIMENTS

Hereafter, the present invention is described in detail with reference to the drawings.

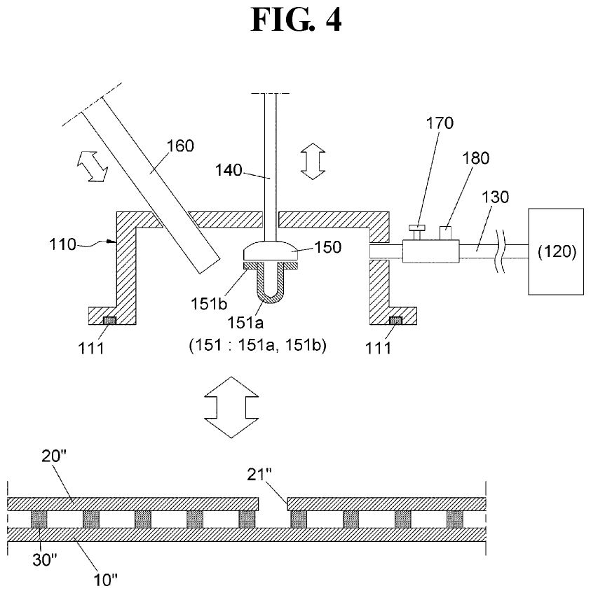

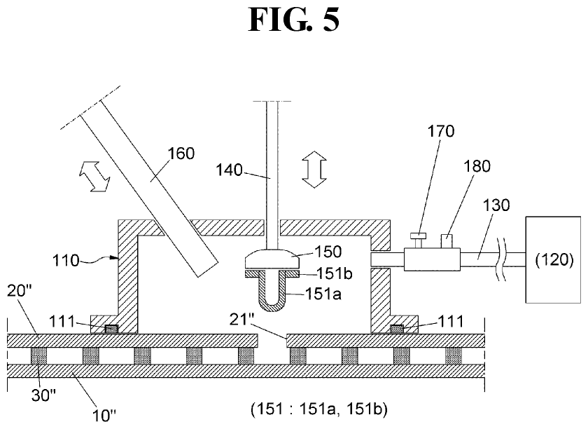

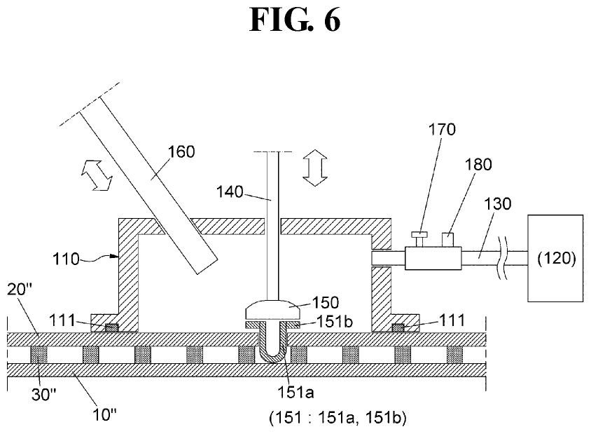

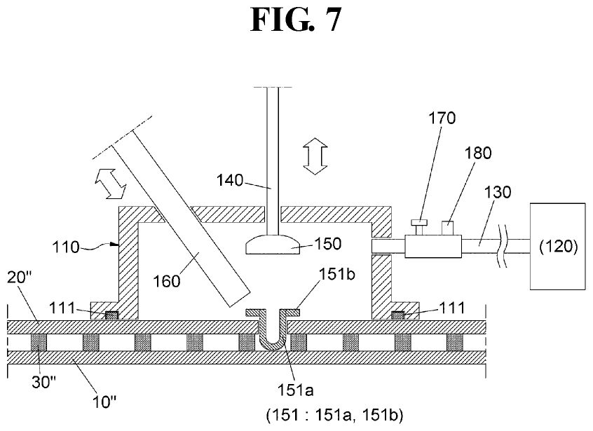

FIG. 4 is an exemplary view schematically showing a device for manufacturing vacuum-insulated glass according to the present invention. FIG. 5 is a view showing a state in which the manufacturing device of FIG. 4 is seated on the top of a second glass panel 20″. FIG. 6 is a view showing a state in which a stroke member 140 has moved down a sealing cap gripping member 150 in FIG. 5. FIG. 7 is a view showing a state in which the stroke member 140 has moved up the sealing cap gripping member 150 separated from the sealing cap 151 in FIG. 6.

Referring to FIGS. 4 to 7, the present invention relates to a device for manufacturing vacuum-insulated glass formed by stacking a first glass panel 10″ and a second glass panel 20″ having a through-vent 21″. The device for manufacturing vacuum-insulated glass according to the present invention may include a vacuum cover member 110, a vacuum pumping member 120, a vacuum pipe member 130, a stroke member 140, a sealing cap gripping member 150, a bonding-hardening member 160, a pressure gauge member 170, and a vent member 180.

The vacuum cover member 110 may be in close contact with a first surface of the second glass panel 20″ that is a one-side glass panel of the vacuum-insulated glass.

The vacuum cover member 110 may be in close contact with the first surface of the second glass panel 20″ that corresponds to the opposite side of the first glass panel 10″ in the form of covering a predetermined region of the second glass panel 20″ including the through-vent 21″. To this end, the vacuum cover member 110 is formed in a cap shape with an empty inside and may have a circular O-ring member 111 on the bottom of the edge portion thereof. When the O-ring member 111 is in close contact with the first surface of the second glass panel 20″, the inside of the vacuum cover member 110 can be hermetically maintained to the outside.

As described above, preferably, suction can be performed by the vacuum pumping member 120 with the hermetic state maintained between the vacuum cover member 110 and the second glass panel 20″ by the O-ring member 111.

The vacuum pumping member 120 may communicate with the vacuum cover member 110. The vacuum pumping member 120 can suction the air between the first glass panel 10″ and the second glass panel 20″ via the vacuum cover member 110 through the through-vent 21″. As a result, the space between the first glass panel 10″ and the second glass panel 20″ is maintained in a vacuum state. In this case, a crushing external force that is applied to the first glass panel 10″ and the second glass panel 20″ due to vacuum pressure between the first glass panel 10″ and the second glass panel 20″ is supported by a plurality of spacers 30″ disposed between the first glass panel 10″ and the second glass panel 20″.

The vacuum pipe member 130 may be disposed such that the vacuum pumping member 120 communicates with the inside of the vacuum cover member 110. The vacuum pipe member 130, preferably, may hermetically communicate with the inside of the vacuum cover member 110 through a pipe that guides a straight motion of the stroke member 140.

The stroke member 140 is disposed through the vacuum cover member 110 and is configured to move into and out of the vacuum cover member 110 with the inside and outside of the vacuum cover member 110 sealed.

The sealing cap gripping member 150 may be connected to the front end of the stroke member 140 that corresponds to the inside of the vacuum cover member 110.

The sealing cap gripping member 150 can grip or release the sealing cap 151 at the lower end thereof and can move straightly in linkage with the reciprocation of the stroke member 140. As a result, the sealing cap gripping member 150 moves to the through-vent 21″ with a sealing cap 151 for sealing the through-vent 21″ gripped at the lower end and then releases the sealing cap 151.

In this configuration, the sealing cap gripping member 150 may be made of an electromagnet. As a result, the device may be configured to grip or release the sealing cap 151 by controlling on-off of the power that is supplied to the electromagnet. To this end, it is preferable that the sealing cap 151 is made of a conductive metal material. When the sealing cap gripping member 150 is made of an electromagnet as described above, the device can be operated to generate magnetism that can grip the sealing cap 151 in the state of FIG. 4 and to remove magnetism for the sealing cap 151 in the states of FIGS. 6 and 7.

The bonding-hardening member 160 may be elongated from the outside of the vacuum cover member 110 through the vacuum cover member 110 into the vacuum cover member 110. In this configuration, it is preferable that the bonding-hardening member 160 is configured to reciprocate at the portion where it joins the vacuum cover member 110 while the sealing of the inside and outside of the vacuum cover member 110 is maintained.

The bonding-hardening member 160 can provide any one or more environment of UV irradiation, IR irradiation, and SWIR irradiation that is a bonding environment for a bonding material 40 of the sealing cap 151 fastened to the through-vent 21″ in a state of being elongated to the inside of the vacuum cover member 110.

In this configuration, the bonding-hardening member 160 may be configured to reciprocate into and out of the vacuum-cover member 110 by a predetermined distance. In detail, when the sealing cap gripping member 150, which was stroked in downward direction as shown in FIGS. 5 and 6, releases the sealing cap 151 and then is stroked in upward direction as shown in FIG. 7, the bonding-hardening member 160 may maintain a state in which it is stroked rearward as shown in FIGS. 5 and 6, and then be stroked forward as shown in FIG. 7.

The pressure gauge member 170 may communicate with the vacuum pipe member 130. The pressure gauge member 170 can display vacuum pressure generated between the first glass panel 10″ and the second glass panel 20″ in accordance to the operation of the vacuum pumping member 120.

The vent member 180 communicates with the vacuum pipe member 130 and can release vacuum pressure generated between the first glass panel 10″ and the second glass panel 20″ when the vent member 180 is opened.

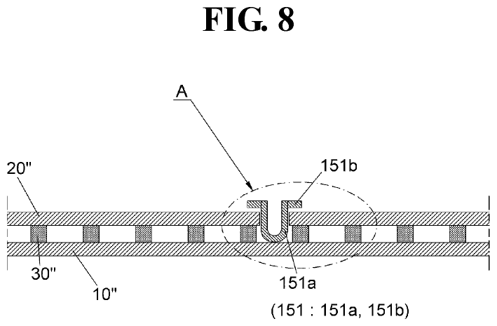

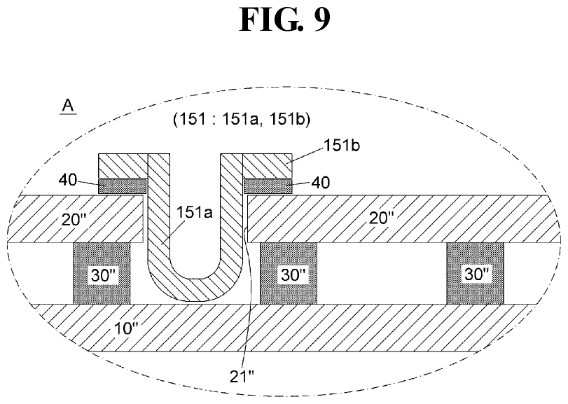

FIG. 8 is a view showing a state in which the manufacturing device of FIG. 7 has been separated from the top surface of the second glass panel. FIG. 9 is an enlarged view showing a portion of FIG. 8.

The sealing cap 151 may include a sealing body member 151a and a sealing flange member 151b.

The sealing body member 151a may be formed in a cylindrical shape with a closed front end and may be extended to and placed on a first surface of the first glass panel 10″, which faces the second glass panel 20″, via the through-vent 21″.

The sealing flange member 151b may be bent outward from the edge of the rear end of the sealing body member 151a, so the sealing flange member 151b may be held on the first surface of the second glass panel 20″ that corresponds to the opposite side of the first glass panel 10″.

In this case, the bonding material 40 may be disposed on the bottom of the sealing flange member 151b, and as shown in FIG. 7, when the bonding-hardening member 160 operates and generates heat, the bonding material 40 on the bottom of the sealing flange member 151b is melted, whereby the bottom of the sealing flange member 151b and the top surface of the second glass panel 20″ can be brought in close contact with each other. Thereafter, when a predetermined time passes, the molten bonding material 40 hardens, whereby the bottom of the sealing flange member 151b and the top surface of the second glass panel 20″ can be firmly connected.

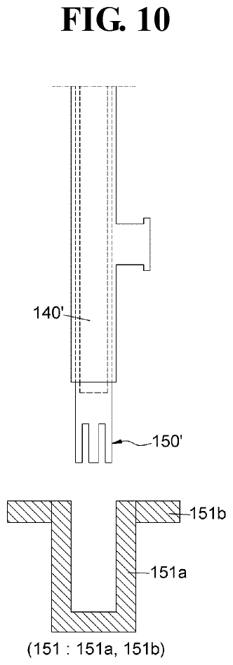

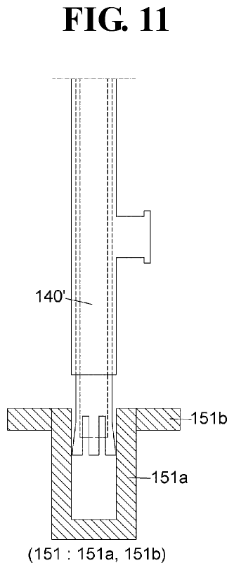

FIGS. 10 to 13 show only a stroke member and a sealing cap gripping member in another embodiment of the present invention. FIG. 10 is an exemplary view showing a state before a sealing cap gripping member grips a sealing cap. FIG. 11 is an exemplary view showing a state immediately after the sealing cap gripping member grips the sealing cap.

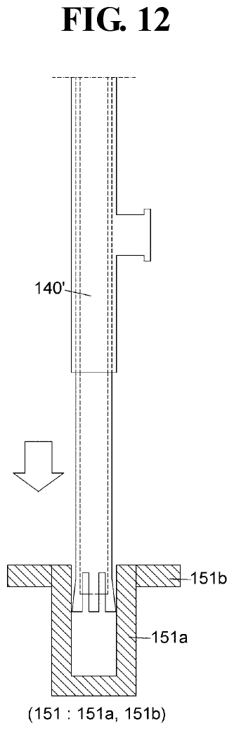

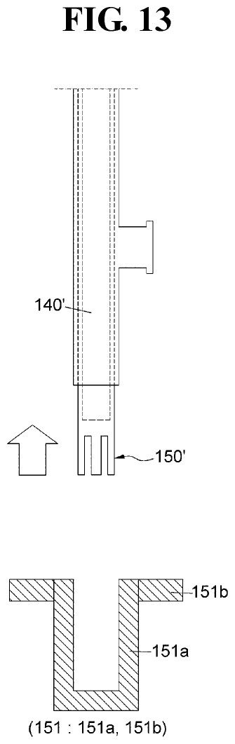

FIG. 12 is an exemplary view showing a state in which the stroke member has been straightly moved down in the state of FIG. 11. FIG. 13 is an exemplary view showing a state in which the stroke member has been straightly moved up after the sealing cap gripping member released the sealing cap.

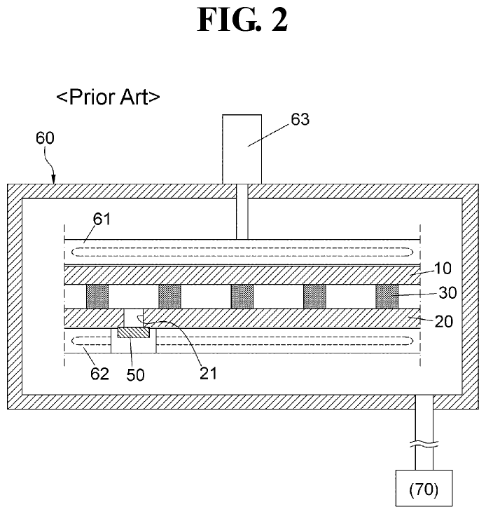

According to another embodiment of the present invention, a sealing gap gripping member 150′ of the present invention may be configured to mechanically grip a sealing cap 151 as shown in FIGS. 11 and 2, or to release the sealing cap 151 as shown in FIGS. 10 and 13.

For example, the sealing cap gripping member 150′ may be configured to laterally open its body as shown in FIGS. 11 and 12, or to return its body to the initial position as shown in FIGS. 10 and 13, as in a fastening principle of an anchor bolt.

To this end, a stroke member 140′ may have a two-stage coaxial shape.

In this configuration, an outer stroke part is connected to the rear end of the sealing cap gripping member 150′ to straightly move in a pipe, which guides a straight motion thereof, and straightly move integrally with the sealing cap gripping member 150′.

Further, an inner stroke part is straightly moved in the outer stroke part in the longitudinal direction of the outer stroke part, and as shown in FIGS. 11 and 12, as the inner stroke part is moved down, the front end thereof can enter the sealing cap gripping member 150′ and laterally expand the body of the sealing cap gripping member 150′.

When the body of the sealing cap gripping member 150′ is laterally expended, it is possible to grip the inner side of the sealing body member 151a, as shown in FIGS. 11 and 12.

Further, as the inner stroke part is moved up in the longitudinal direction of the outer stroke part as shown in FIGS. 10 and 13, the front end thereof comes out of the sealing cap gripping member 150′, so the body of the sealing cap gripping member 150′ can be returned into the initial shape as shown in FIGS. 10 and 13.

1. A device for manufacturing vacuum-insulated glass that is formed by stacking a first glass panel and a second glass panel having a through-vent, the device comprising:
a vacuum cover member being in close contact with a first surface of the second glass panel that corresponds to an opposite side of the first glass panel in the form of covering a predetermined region of the second glass panel including the through-vent;
a vacuum pumping member communicating with the vacuum cover member and configured to suction air between the first glass panel and the second glass panel via the vacuum cover member through the through-vent;
a vacuum pipe member disposed such that the vacuum pumping member communicates with an inside of the vacuum cover member;
a stroke member disposed through the vacuum cover member and configured to move into and out of the vacuum cover member with the inside and outside of the vacuum cover member sealed; and
a sealing cap gripping member connected to a front end of the stroke member that corresponds to the inside of the vacuum cover member, configured to straightly move in linkage with a stroke of the stroke member, and configured to move to the through-vent with a sealing cap for sealing the through-vent gripped thereby and then to release the sealing cap.

2. The device of claim 1, further comprising:
a bonding-hardening member elongated from an outside of the vacuum cover member through the vacuum cover member to the inside of the vacuum cover member with the inside and outside of the vacuum cover member sealed, and configured to provide a bonding environment for a bonding material of the sealing cap fastened to the through-vent.

3. The device of claim 2, further comprising:
a pressure gauge member communicating with the vacuum pipe member and configured to display vacuum pressure generated between the first glass panel and the second glass panel in accordance to the operation of the vacuum pumping member.

4. The device of claim 3, further comprising:
a vent member communicating with the vacuum pipe member and configured to release the vacuum pressure generated between the first glass panel and the second glass panel when being opened.

5. The device of claim 4, wherein the sealing cap includes:
a sealing body member formed in a cylindrical shape with a closed front end and configured to be extended to and placed on a first surface of the first glass panel facing the second glass panel through the through-vent; and
a sealing flange member to be bent outward from an edge of a rear end of the sealing body member and configured to be held on the first surface of the second glass panel that corresponds to an opposite side of the first glass panel.

6. The device of claim 5, wherein the sealing cap gripping member is made of an electromagnet.
